(19) United States
(12) Patent Application Publication
(10) Pub. No.: US 2017/0051581 A1
(43) Pub. Date: Feb. 23, 2017

(54) MODELING FRAMEWORK FOR VIRTUAL FLOW METERING FOR OIL AND GAS APPLICATIONS

(71) Applicant: General Electric Company, Schenectady, NY (US)

(72) Inventors: Luca Parolini, Garching b. Muchen (DE); Vittorio Michelassi, Niskayuna, NY (US)

(21) Appl. No.: 14/830,471

(22) Filed: Aug. 19, 2015

(51) Int. Cl. E21B 41/00; G05B 13/04; E21B 47/00

(52) U.S. Cl. CPC E21B 41/0092; E21B 47/00; G05B 13/041

(57) ABSTRACT

A method of operating a hydrocarbon extraction field with the aid of a computer includes programming the computer with a virtual flow meter model. The model may be written with a notation that represents at least one of mass flow, temperature and pressure at extremities of a plurality of pressure loss elements (PLEs). The PLEs may include a plurality of wells located in the hydrocarbon extraction field. The method may further include the computer estimating, with use of the model, respective mass flow rates from a plurality of the wells. The method may further include controlling elements of the hydrocarbon extraction field based at least in part on the estimated mass flow rates.

### BACKGROUND

Operation of an undersea oil and/or gas production field typically involves complex installations of equipment to gather, route and control fluids produced from the wells in the field. Sensors are commonly installed with the fluid collection/distribution elements to detect conditions such as pressure, temperature and/or mass flow at particular points in the installed equipment. The equipment may include pipes, valves (also sometimes referred to as “chokes”), manifolds and/or other elements through which fluids may flow.

To supplement data directly available from sensors, the concept of “virtual flow metering” has arisen. Virtual flow metering may use mathematical modeling techniques to estimate conditions at various points in the installed equipment. However, existing examples of virtual flow meter (VFM) modeling are limited in their capabilities, may suffer from significant inaccuracies in the resulting estimates, and may be insufficient to support modeling of complex and extensive equipment installations. Moreover, existing VFM approaches may require repeated and extensive tuning, and may eventually go out of tune in a manner which is not reversible, possibly necessitating abandonment of the model itself at the installation in question.

### BRIEF DESCRIPTION

According to some embodiments, a method of operating a hydrocarbon extraction field is performed with the aid of a computer. The method may include programming the computer with a virtual flow meter model. The model may be written with a notation that represents mass flow, temperature and/or pressure at extremities of a plurality of pressure loss elements (PLEs). The PLEs may include a plurality of wells located in the hydrocarbon extraction field. The method may further include estimating, by the computer, using the virtual flow meter model, respective mass flow rates from a plurality of the wells. Elements of the hydrocarbon extraction field may then be controlled based at least in part on the estimated mass flow rates.

### DRAWINGS

FIG. 1 is a block schematic diagram of a hydrocarbon extraction field and associated installations, including a computer used in operating the hydrocarbon extraction field in accordance with some embodiments.

FIG. 2 is a block diagram showing some details of an example embodiment of the computer shown in FIG. 1.

FIG. 3 illustrates a simplified example of a pressure loss graph.

FIG. 4 is another representation of the pressure loss graph of FIG. 3.

FIG. 5 is a diagram that illustrates notation conventions for mass flow at extremities of a PLE according to some embodiments.

FIG. 6 is flow chart that illustrates a process according to some embodiments.

### DETAILED DESCRIPTION

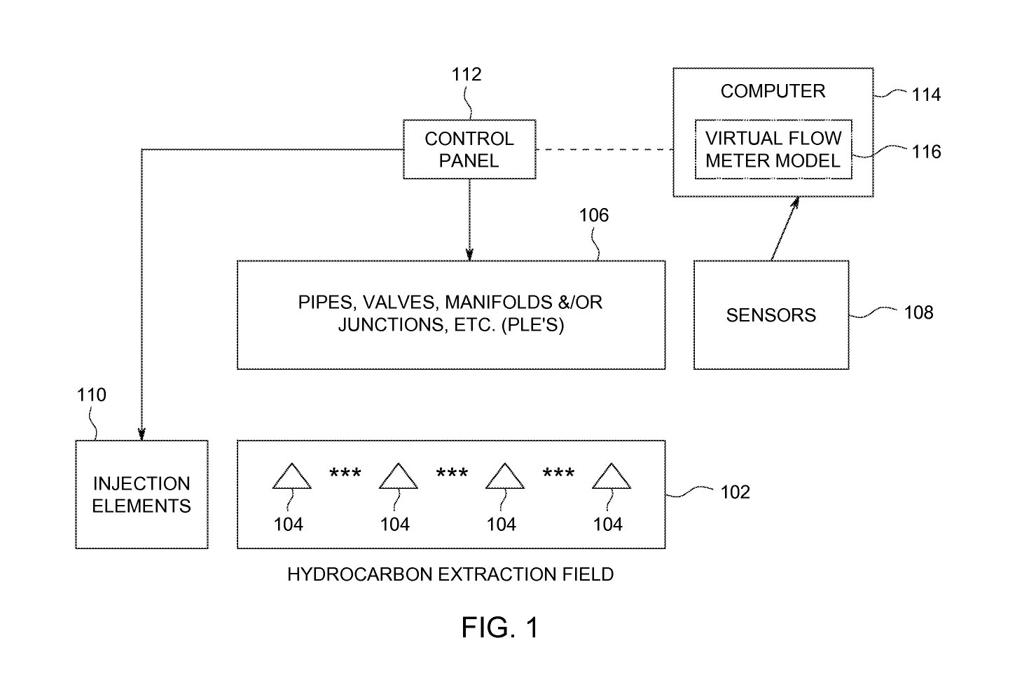

FIG. 1 is a block schematic diagram of a hydrocarbon extraction field and associated installations, according to some embodiments. Block 102 itself represents the hydrocarbon extraction field, which may include a number of oil and/or gas wells 104. Block 106 represents, collectively, various pipes, valves, manifolds, junctions, compressors, venturis and/or other elements that may contain, direct, distribute and/or control flow of fluids issuing from the wells 104. Block 108 represents sensors installed in association with elements of the equipment installation represented by block 106 to show conditions at certain points in the installed equipment. The conditions may include one or more of mass flow, temperature and pressure.

In some embodiments, the hydrocarbon extraction field 102 may be on the ocean floor; i.e., the field may be an undersea field. Accordingly, at least a portion of the equipment represented by block 106 may be located below the ocean surface. It will be understood that inclusion of the sensors 108 with the equipment installation 106 may be expensive and the sensors may placed in a limited number of locations relative to the installed equipment so as to provide data only at a portion of the possible locations for which knowledge of conditions may be desired. It will also be understood that sensors may fail at times and that it may not be feasible to replace the sensors that have failed.

Block 110 represents elements of equipment by which chemical effluents may be injected into the hydrocarbon extraction field in accordance with known practices to stimulate production of oil and/or gas from the wells 104. The injection elements may be controlled by a human operator (not shown) via a control panel 112. In some embodiments, the control panel may also be operable to control one or more elements (e.g., valves) included in the installed equipment 106.

The data provided by the sensors 108 may be received at and by a computer 114 provided according to some embodiments. A suitable interface or interfaces (not shown in FIG. 1) may be provided to facilitate receipt of the sensor data by the computer 114. The computer 114 may be programmed with a virtual flow meter model 116 according to some embodiments. Details of the virtual flow meter model 116 will be described below.

In some embodiments, the hardware making up the computer 114 may overlap with the control panel 112 and/or there may be a data communication channel between the computer 114 and the control panel 112.

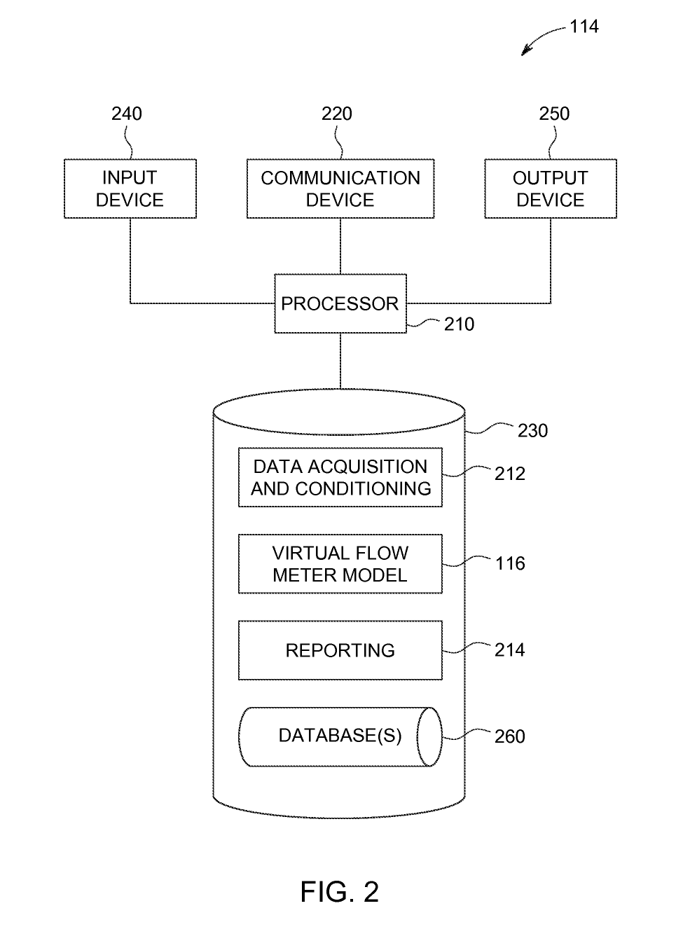

FIG. 2 is a block diagram showing some details of an example embodiment of the computer 114 shown in FIG. 1.

The computer 114 comprises a processor 210, such as one or more commercially available Central Processing Units (CPUs) in the form of one-chip microprocessors, coupled to a communication device 220 configured to communicate via a communication network (not shown in FIG. 2). The communication device 220 may be used to communicate, for example, with one or more other devices. The computer 114 further includes an input device 240 (e.g., a mouse and/or keyboard to enter information about model algorithms) and an output device 250 (e.g., to output estimate data provided by the virtual flow meter model 116). The input device 240 may also include one or more data interfaces to receive the sensor data referred to above.

The processor 210 also communicates with a storage device 230. The storage device 230 may comprise any appropriate information storage device, including combinations of magnetic storage devices (e.g., a hard disk drive), optical storage devices, mobile telephones, and/or semiconductor memory devices. The storage device 230 stores a data acquisition and conditioning program 212 for controlling the processor 210 so that the processor 210 can arrange the sensor data in appropriate form for processing by the computer 114. The storage device 230 also stores the above-mentioned virtual flow meter model 116. Further, the storage device 230 may store a reporting program 214 to allow the computer 114 to report via the output device 250 results of estimates produced by the virtual flow meter model 116. The processor 210 performs instructions of the programs/model 212, 116, 214, and thereby operates in accordance with any of the embodiments described herein. For example, the processor 210 may receive sensor data, perform an estimation process by using the virtual flow meter model 116 and report results of the estimation process to a human operator.

The programs 212, 214 and/or the model 116 may be stored in a compressed, uncompiled and/or encrypted format. Programs stored in the storage device 230 may furthermore include other program elements, such as an operating system, a database management system, and/or device drivers used by the processor 210 to interface with peripheral devices.

As used herein, information may be “received” by or “transmitted” to, for example: (i) the computer 114 from another device; or (ii) a software application or module within the computer 114 from another software application, module, or any other source.

In some embodiments (such as shown in FIG. 2), the storage device 230 includes one or more databases 260 that may store, for example, sensor data received and stored over time, and/or results of estimation processes performed over time by the computer 114.

Details of the virtual flow meter model 116 will now be discussed.

As an initial stage of describing the virtual flow meter model 116, a discussion of notation will now be presented.

In this disclosure, vectors are denoted with bold case letters and are column-wise. The symbol T is the transpose operator. Let x be a N×1 vector and I be an ordered set of indexes having values between 1 and N. With xᵢ we denote the i^{th} element of x and with Iᵢ we denote the i^{th} element of I . With x_{[I]} we denote the vector composed of the elements of x having index in I.

Consider x=[a b c d e]^{T} and I={1,3}. Then

x₂=b, I₂=3, x_{[I]}=[a c]^{T}

x_{I}_{₁}=a, and x_{I}_{₂}=c.

Time is denoted with the letter t. The models described in this disclsoure, focus on stationary models of pressure and temperature. Toward this goal, we denote with t̅ the time used in the models and with t the actual time. This approach is used in order to filter out fast behaviors that are not relevant for the models.

A Virtual Flow Meter (VFM) is an estimator which attempts to compute relevant properties of a fluid by combining real-time measured data and a variety of models that relate the relevant fluid properties to the measured data. This disclosure proposes one possible notation for an approach for formalizing the VFM problem.

The network of pipes and chokes and other equipment items that transports the fluids from the wells to the processing station and that allows the injection of chemicals with a directed graph G={E;N}. The set E represents the collection of physical elements within which the fluids move. The set N represents the junction points where multiple fluids mingle. The set E is called the set of edges and the set N is called the set of nodes. The letters E and N denote the number of edges and nodes in the graph respectively. The graph G is called pressure loss graph (PLG) and the elements of the sets E and N are called pressure loss elements (PLEs).

PLEs are ordered and we can refer to the j^{th} PLE, where j takes integer values from 1 to N+E, independently from whether the j^{th} PLE is a node or an edge. PLEs have extremities where the fluid enters or exits the PLE. An extremity where the fluid enters a PLE is called an inlet. An extremity where the fluid leaves a PLE is called an outlet. Inlets and outlets of PLEs are classified based on the direction of the edges.

Extremities in the graph have a global order. Every PLE is associated to a set of indexes which identifies the extremity of the PLE. With I^{j} we denote the set of indexes of extremities associated with the j^{th} PLE. With ⁺I^{j} we denote the set of indexes of inlets associated with the j^{th} PLE. With ⁻I^{j}we denote the set of indexes of outlets associated with the j^{th} PLE. By construction we have that

I^{j}=⁺I^{j}∪⁻I^{j} and ⁺I^{j}∩⁻I^{j}=Ø, for all j=1, . . . , N+E.

Edges have one inlet and one outlet only. Nodes can have multiple inlets and outlets. We consider the following convention:

the inlet of an edge is connected to an outlet of a node;

the outlet of an edge is connected to the inlet of a node.

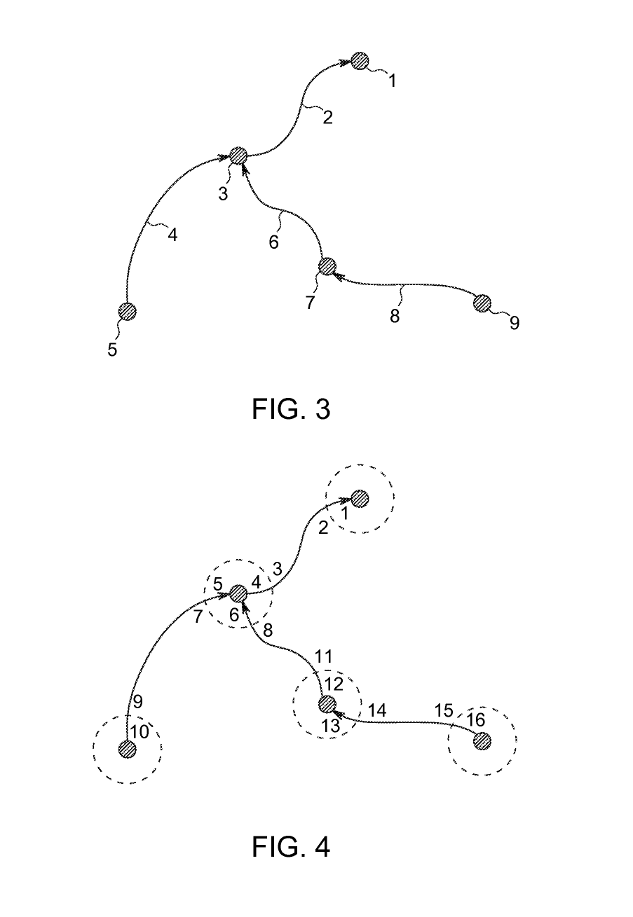

FIG. 3 shows a simplified example of a PLG and a possible ordering of the simplified example collection of PLEs shown in FIG. 3. As illustrated in FIG. 3, indexes 1,3,5,7, and 9 are associated with nodes. Indexes 2,4,6, and 8 are associated with edges.

FIG. 4 is another view of the example PLG of FIG. 3 and shows the classification of extremities of every PLE between inlet and outlet and also, it shows the selected order for the extremities. In FIG. 4, the indexes of PLEs are not shown for the sake of a less cluttered image. The graph in FIG. 4 is associated with the following sets.

I¹={1}, I²={2, 3}, I³={4, 5, 6}, I⁴={7, 9},

I⁵={10}, I⁶={8, 11}, I⁷={13, 12}, I⁸={14, 15}, I⁹={16}

⁺I¹=Ø, ⁻I¹={1}, ⁺I²={3}, ⁻I²={2}, ⁺I³={5, 6}, ⁻I³={4}

The model now being described is concerned with a 3-phase fluid composed of oil, water and gas. The presence of solids is neglected. Between the oil and the gas phase there is a continuous exchange of mass and the amount of fluid that stays in the gas, or in the oil phase, depends on the temperature and pressure conditions of the fluid. In this disclosure, we consider the rates at which the phases move through the system as if they were at standard conditions (SC). (SC are defined as 0° C. and 100,000 kPa.)

Among the key properties of a fluid, we consider mass flow, temperature, and pressure . Mass flow is measured in kilogram per second [kg/s], temperature is measured in degree Celsius [C], and pressure is measured in kilo-Pascal (kPa).

With Pⱼ(t̅) and Tⱼ(t̅) we denote the pressure and the temperature values at the j^{th}extremity at time t̅. With the 3×1 vector mⱼ(t̅) we denote the rate at which the phases of the fluid crosses the j^{th} extremity at time t̅. Pressure and temperature values at extremities are scalar values, whereas mass flow values are vectors. The first element of the mass flow vector represents the rate at which the oil phase crosses the extremities. The second element represents the rate at which the water phase crosses the extremities. The third element represents the rate at which the gas phase crosses the extremities.

In general, the phases of a fluid can cross an extremity with different directions. This is a rare event under stationary conditions, and for present purposes it is sufficient to implement the model on the simplified case where all of the phases move along the same direction and we define the fluid direction as the direction of its phases.

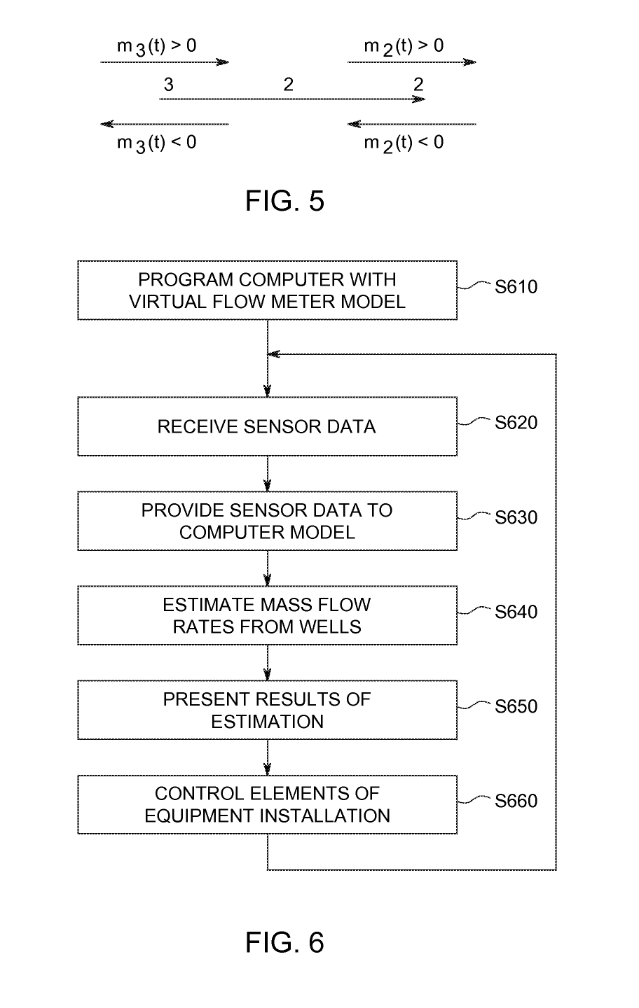

If j is an inlet, then a positive value of mⱼ(t̅) represents the case where the fluid enters the PLE associated with the j^{th} extremity. A negative value of mⱼ(t̅) represents the case where the fluid leaves the PLE associated with the extremity. If j is an outlet, then a positive value mⱼ(t̅) represents the case where the fluid leaves the PLE associated with the j^{th} extremity and negative value of mⱼ(t̅) represents the case where the fluid enters the PLE. Note that mass flow, pressure, and temperature values are associated with extremities and not with PLEs. FIG. 5 shows the direction of the mass flow for the PLE of index 2 in the case of positive and negative signs of m₂(t̅) and m₃(t̅) .

Mass flow, pressure, and temperature values in a PLG can be grouped into vectors denoted with M(t̅), P(t̅), and T(t̅) respectively. The pressure and temperature values at the extremities of the j^{th} PLE are given by P_{[Ij]}(t̅) and T_{[Ij]}(t̅). The mass flow vector has different dimension than the pressure and temperature vector. With an abuse of notation (which will nonetheless allow those skilled in the art to understand the intended meaning), we denote with M_{[Ij]}(t̅) the vector of mass flow values at the extremities of the j^{th} PLE.

Between two connected extremities, mass flow, temperature, and pressure values are identical. The relationships can be expressed as

AM(t̅)=0, BP(t̅)=0, BT(t̅)=0 (Eq. 1)

where A and B are matrices of appropriate dimensions and whose elements take values in the set [−1,0,1}.

(|Due|_{[LP1]} to the way the matrices M(t̅) , P(t̅) and T(t̅) are constructed, the following relationship holds true:

$$A = B ⊗ [ \begin{matrix}1 & 0 & 0 \\ 0 & 1 & 0 \\ 0 & 0 & 1\end{matrix} ] ,$$

where [symbol] denotes the Kronecker product.)

With respect to the PLG in FIG. 3, the pair of extremities with identical mass flow, temperature and pressure are

{1, 2}, {3,4}, {5, 7}, {6, 8}, {9, 10}, {11, 12 }

The matrix B is therefore:

$$B = [ \begin{matrix}1 & - 1 & 0 & 0 & 0 & 0 & … & \\ 0 & 0 & 1 & - 1 & 0 & 0 & … & \\ 0 & 0 & 0 & 0 & 1 & 0 & - 1 & … \\ ⋮ & & & … & & & & \end{matrix} ]$$

Subsequent portions of this disclosure will discuss how various elements of a PLG may be modeled in accordance with some embodiments.

Modeling of junction points will now be discussed.

Junction points are physical locations where fluids join or divide. Junction points are nodes of a PLG, e.g., node 3 in FIG. 3 represents a junction point. At every point in time, the total mass flow that enters the junction point equals the total mass flow that leaves the junction point. Pressure values are identical at each extremity of a given junction point. In general, no restriction applies to temperature values. If j is the index of a junction point, then the relationship among the mass flow values can be written as

$${\sum }_{i ∈ {}_{}^{+}{ℐ}{}_{}^{j}} {m}_{i} ( \overline{t} ) = {\sum }_{k ∈ {}_{}^{-}{ℐ}{}_{}^{j}} {m}_{k} ( \overline{t} ) \qquad ( Eq . 2 )$$

and the relationship among the pressure values can be written as

Pₖ(t̅)=Pₗ(t̅), for all k, l∈I^{j} (Eq. 3)

Modeling of wells will now be discussed.

Wells may be modeled as nodes of the PLG with only one extremity, which is an outlet. Wells can be considered as nodes where the pressure at the outlet is constant and independent of the mass flow. In other embodiments, more complex relationships among pressure, mass flow and temperature may be defined in modeling wells. For example, in some embodiments, inflow performance relationships (IPR), could be used, as discussed below.

Let j be the index of an extremity of a PLE representing a well. A well modeled as a source of mass flow at constant pressure could be represented as:

Pⱼ(t̅)=P̅ⱼ (Eq. 4)

IPR models may be considered via the generic function

F_{well,j}(mⱼ(t̅), T_{I}_{^{j}}, P_{I}_{^{j}})=0 (Eq. 5)

In some embodiments, more complex models of wells may be employed, including models in which wells are considered to have more than one extremity

Modeling of chokes (i.e., valves) will now be discussed.

Chokes may be modeled as edges or nodes of a PLG. Chokes have one inlet and one outlet only and the mass flow at the inlet equals the mass flow at the outlet. A generic relationship between mass flow, temperature and pressure between the inlet and the outlet can be written as

F_{choke, j}(m_{I}_{₁}_{^{j}}(t̅), T_{I}_{^{j}}, P_{I}_{ⁱ})=0 (Eq. 6)

m_{I}_{₁}_{^{j}}(t̅)=m_{I}_{₂}_{^{j}}(t̅) (Eq. 7)

The function F_{choke, j} represents the pressure and temperature drop model used for the choke having index j. Examples of suitable models are the Sachdeva model or models available in the “OLGA” software simulation package. Those who are skilled in the art are familiar with such models.

Modeling of pipes will now be discussed.

Pipes have one inlet and one outlet and are naturally represented as edges of the PLG. Pressure and temperature drop models for pipes may describe the pressure and temperature gradient with respect to the length of the pipe. With Lⱼ we denote the length of the pipe having index j and with xⱼ we denote a point in the interval [0, Lⱼ]. In some embodiments, length may be measured in meters [m]. The inlet of the pipe coincides with xⱼ=0 and the outlet coincides with xⱼ=Lⱼ.

For pipes, the mass flow at the inlet equals the mass flow at the outlet. This can be written as

m_{I}_{₁}_{^{j}}(t̅)=m_{I}_{₂}_{^{j}}(t̅) (Eq. 8)

With P(t̅, xⱼ) we denote the pressure of the fluid at position xⱼ at time t̅ and with T(t̅, xⱼ) we denote the temperature of the fluid at position xⱼ at time t̅. With

$$With \frac{d P ( \overline{t} , {x}_{j} )}{d {x}_{j}} and \frac{d T ( \overline{t} , {x}_{j} )}{d {x}_{j}} \vert [ LP 2 ]$$

we denote the gradients of pressure and temperature along the length of the pipe respectively.

The pressure and temperature drop models of a pipe can be written as

$$\begin{matrix}[ \begin{matrix}\frac{d P ( \overline{t} , {x}_{j} )}{d {x}_{j}} \\ \frac{d T ( \overline{t} , {x}_{j} )}{d {x}_{j}}\end{matrix} ] = {F}_{pipe , j} ( {m}_{j} ( \overline{t} ) , {T}_{{ℐ}^{j}} ( \overline{t} , {x}_{j} ) , {P}_{{ℐ}^{j}} ( \overline{t} , {x}_{j} ) ) & ( Eq . 9 ) \\ [ \begin{matrix}P ( \overline{t} , 0 ) \\ T ( \overline{t} , 0 )\end{matrix} ] = [ \begin{matrix}{P}_{i} ( \overline{t} ) \\ {T}_{i} ( \overline{t} )\end{matrix} ] , i ∈ {}_{}^{+}{ℐ}{}_{}^{j} & ( Eq . 10 ) \\ [ \begin{matrix}P ( \overline{t} , {L}_{e} ) \\ T ( \overline{t} , {L}_{e} )\end{matrix} ] = [ \begin{matrix}{P}_{o} ( \overline{t} ) \\ {T}_{o} ( \overline{t} )\end{matrix} ] , o ∈ {}_{}^{-}{ℐ}{}_{}^{j} & ( Eq . 11 )\end{matrix}$$

Modeling of the PLG as a whole will now be discussed.

An overall model of a PLG may be obtained by combining the models of the PLEs as described above into a unified system of equations. The equality relationships discussed above can be rewritten in terms of matrix multiplication operations and grouped with Equation 1. The overall equality constraints can then be rewritten as

A̅M(t̅)=0, B̅P(t̅)=0, B̅T(t̅)=0 (Eq. 12)

Modeling of measured data will now be discussed.

Data collected from sensors at time t are collected into a vector z(t) of dimension M×1. The function that relates mass flow, temperature and pressure to the measured data can be generically described as

\hat{z}(t̅)=h(M(t̅), P(t̅), T(t̅)) (Eq. 13)

, where the vector \hat{Z}(t̅) represents the expected measured vales. (In some embodiments, the function h may depend on just a few elements of the vectors M(t̅), P(t̅) and T(t̅) and on additional parameters that may include, for example, ambient temperature or other relevant conditions.)

In some embodiments, the model addresses the case where data are collected with a fixed sampling period of length T. Data collected over the k^{th} sampling time are denoted as z(k)=z(t₀+kT) for a certain t₀. Equation 13 can be rewritten as

\hat{z}(k)=h(M(k), P(k), T(k)) (Eq. 14)

There will now be a discussion of representing the VFM estimation problem as an optimization problem.

Let W denote the set of indexes of PLEs associated with wells and let k denote the current data sample. In some embodiments of the VFM model, the VFM estimation problem may be formalized as a deterministic optimization problem. For this approach, a cost function of the optimization problem is to be identified. Constraints for the optimization problem may be those that have been discussed previously in this disclosure.

In some embodiments, the cost function may be the square value of the difference between the expected sensor output and the measured sensor output over a discrete time interval of length H, i.e., the optimization problem may consider the data sampled at times k−H,k−H+1, . . . , k.

The optimization problem can now be written as (Eq. 15, immediately below)

$${m}^{*} = {argmin}_{\{ {m}_{j} ( i ) \} , j ∈ W} {\sum }_{i = k - H}^{k} {‖ z ( i ) - \hat{z} ( i ) ‖}^{2} ,$$

subject to

\hat{z}(i)=h(M(i), P(i), T(i)),

Model constraints previously discussed,

Mass-flow continuity constraints,

Pressure continuity constraints,

Temperature continuity constraints,

Additional constraints (e.g., GOR, WLR constraints)

(In the above, “GOR” refers to the gas-oil ratio; “WLR” refers to the water-liquid ratio.)

The optimization problem, as stated in Equation 14, does not include equations that relate the value of M (i) to the value of M (i+1). In view of this, the optimization problem can be rewritten as H+1 independent optimization problems, each of which considers data and equations only at a specific point in time.

A potential issue with this approach is that the lack of time dependence could lead to large variations on the estimated mass flow from time i to time i+1. To address this issue, a new equation may be introduced which bounds the rate at which mass flow can change over time steps. The addition of such an equation would lead to a dynamic estimation problem where estimated mass flow at time i affects the estimated mass flow at time i+1.

In other embodiments, constant mass flow may be assumed over the interval k−H, k−H+1, . . . , k. In such embodiments, the solution of Equation 15 would be the value of the constant well mass flow that minimizes the error between the expected and measured data over the interval k−H, k−H+1, . . . , k. This assumption of constant mass flow over the stated interval does not imply that the solution of the optimization problems solved at different times are identical. Let m*(k−H) denote the solution of the optimization problem as solved at time k, i.e., the optimization problem which considers measured data over the interval k−H, k−H+1, . . . , k. It can be expected that m*(k−H) would be different from m *(k−H+1). This difference is due to the different time horizons that the two optimization problems consider. That is, the optimization problem solved at time k, considers the measured data over the interval k−H, k−H+1, . . . , k, whereas the optimization problem solved at time k+1 considers the measured data over the interval k−H+1, k−H+2, . . . , k+1. This approach may lead to solutions which are allowed to vary over time, but whose variations are likely to be smooth. This approach may be referred to as receding horizon.

Some alternative embodiments of the VFM model will now be discussed.

In previously described embodiments, the estimation problem was formalized as a deterministic optimization problem. That is, no uncertainty was considered in the data and no uncertainty was provided in the computed well mass flow. In other embodiments, uncertainty may be included in the data and in the estimated values, and the overall uncertainty may be measured by using a probabilistic approach. If a Bayesian approach is employed, then the model embodiment previously discussed may be interpreted in terms of relationships among the probability distributions of mass flow, pressure, and temperature. In addition, the measured data are associated with a probability distribution and the goal of the VFM model according to such embodiments is the computation of the distribution of the well mass flow given the sequence of measured data over the interval k−H, k−H+1, . . . , k. With appropriate notation, which those who are skilled in the art can readily arrive at based on the foregoing, an optimization problem over the probability distributions can be formulated.

It may be desirable, for some embodiments, to rewrite the pressure and temperature models for pipe elements so that the models appear to be lumped models in the estimation problem. This may overcome potential issues—that might otherwise be encountered—relating to solving two-point boundary value problems. Use of lumped models may also improve computational efficiency and may generally make solution of the estimation problem easier.

An example of lumped models that may be used is set forth below, with equality of pressure and temperature across coupled extremities being neglected.

$$\begin{matrix}[ \begin{matrix}\frac{d P ( \overline{t} , {x}_{j} )}{d {x}_{j}} \\ \frac{d T ( \overline{t} , {x}_{j} )}{d {x}_{j}}\end{matrix} ] = {F}_{pipe , j} ( {m}_{j} ( \overline{t} ) , {T}_{{ℐ}^{j}} ( \overline{t} , {x}_{j} ) , {P}_{{ℐ}^{j}} ( \overline{t} , {x}_{j} ) ) & ( Eq . 16 ) \\ [ \begin{matrix}P ( \overline{t} , 0 ) \\ T ( \overline{t} , 0 )\end{matrix} ] = [ \begin{matrix}{P}_{i} ( \overline{t} ) \\ {T}_{i} ( \overline{t} )\end{matrix} ] , i ∈ {}_{}^{+}{ℐ}{}_{}^{j} & ( Eq . 17 )\end{matrix}$$

This solution to this differential equation can be rewritten as

$$[ \begin{matrix}{P}_{i} ( \overline{t} ) \\ {T}_{i} ( \overline{t} )\end{matrix} ] = {ℱ}_{pipe , j} ( {m}_{j} ( \overline{t} ) , {T}_{{ℐ}^{j}} ( {T}_{i} ( \overline{t} ) ) , {P}_{i} ( \overline{t} ) ) \qquad ( Eq . 18 )$$

Equation 18 shows that the pressure and temperature at the outlet of a pipe can be obtained via a lumped model from the mass flow, temperature and pressure at the inlet.
The solution of Equation 16 would return temperature and pressure value at the inlet and outlet of a pipe as a function of mass flow, and the vector

$$[ \begin{matrix}P ( \overline{t} , 0 ) \\ T ( \overline{t} , 0 )\end{matrix} ] .$$

It is to be noted that this approach breaks continuity of pressure and temperature of the fluid across a few extremities of the PLG.

It may be the case, in some situations, that the estimation problem may have more than one solution. It may well be the case that constraints on continuity of mass flow, pressure and temperature over the PLG will reduce the number of solutions. It may further be the case that a sufficient number of measurements will tend to produce a unique solution.

There will now be a discussion of another form in which the optimization problem may be written. One alternative form follows:

$${u}^{*} arg {min}_{u} {‖ {y}_{M} - y ‖}_{Q}^{2} , \qquad ( Eq . 19 )$$

subject to (Equations 20, 21, 22, 23 and 24, respectively as follows)

$$g ( u , y ) = 0$$

$$Γ u = 0$$

$$Λ y = 0$$

$$\frac{d z ( x )}{d x} = F ( z ( x ) , u ) for x ∈ [ 0 , 1 ]$$

$$Ly = [ \begin{matrix}z ( 0 ) \\ z ( 1 )\end{matrix} ]$$

The vector yM represents the vector of data measured from the hydrocarbon extraction field. The vector y represents the vector of predicted measurements from the field. The vector u is the vector of mass flow that is to be estimated. The vector z represents the vector of temperature and pressure restraints along the length of pipes or other elements when present. Equation 20 represents the constraints given by lumped models such as IPRs and choke models. Equation 21 represents constraints on mass flow continuity and mass flow ratio such as GOR and WLR constraints. These constraints may be linear in u and may reduce the dimension over which the optimization problem is solved. Equation 22 represents constraints on the continuity of pressure and temperature across adjacent extremities. Equation 23 represents constraints on temperature and pressure evolution along pipes in the PLG. These latter constraints do not depend on the vector y. Equation 24 represents the boundary conditions for the distributed models. The latter set of constraints is the only relationship between the vectors y and z. The matrix Q is the cost function used to weight differences among measured and predicted data.

FIG. 6 is flow chart that illustrates a process according to some embodiments.

At S610 in FIG. 6, the computer 114 is programmed with one or more of the VFM models described above.

At S620, the computer 114 receives data output from the sensors 108 (FIG. 1).

At S630, the sensor data is provided to the VFM model.

At S640, the VFM model is used to estimate mass flow rates from wells 104 (FIG. 1).

At S650, the computer 114 (e.g., via an output device 250, FIG. 2) provides the results of the estimation at S640 to a human operator.

At S660, the human operator, if he/she deems it advisable in view of the estimation results presented at S650, may control one or more elements of the installed equipment, such as controlling one or more effluent injection elements and/or one or more valves.

The steps S620 through S660 may be performed as a continuing process. In some situations, the operator may use the information presented at S650 to determine whether one or more maintenance operations should be performed.

In some embodiments, the computer 114 may employ machine intelligence based on the results of S640 to directly and automatically control controllable elements of the equipment installation.

In some embodiments, the VFM model may be arranged to estimate flows in the extraction field other than or in addition to mass flows from wells.

In some embodiments, the VFM model may include bounds that are input by the human operator based on his/her knowledge of characteristics of the extraction field. This may aid in obtaining unique solutions to the estimation problem.

It is believed that the type of VFM model described above may provide greater accuracy in its estimates than VFM models that have previously proposed. Further, unlike previous models, the VFM models described herein may facilitate modeling together of disparate sections of an extraction field. It is to be expected that some tuning of the VFM model described herein may be required, but after initial tuning the model may operate in a manner such that it essentially self-tunes, so that subsequent tuning operations will not be needed and/or eventual disablement of the model due to going out of tune will not occur.

The VFM model described above may be flexible enough to continue to make accurate estimates even as, over time, certain sensors fail and cease to provide ongoing data.

The particular example hydrocarbon extraction field illustrated herein was assumed to be an undersea field, but the teachings of this disclosure, and the VFM modeling described herein, are also applicable to hydrocarbon extraction operations on land.

The flow chart described herein should not be taken to imply a fixed order to the steps, and embodiments of the present invention may be practiced in any order that is practicable, including simultaneous performance of at least some steps. Note that any of the methods described herein may be performed by hardware, software, or any combination of these approaches. For example, a computer-readable storage medium may store thereon instructions that when executed by a machine result in performance according to any of the embodiments described herein.

It is to be understood that not necessarily all such objects or advantages described above may be achieved in accordance with any particular embodiment. Thus, for example, those skilled in the art will recognize that the systems and techniques described herein may be embodied or carried out in a manner that achieves or optimizes one advantage or group of advantages as taught herein without necessarily achieving other objects or advantages as may be taught or suggested herein.

While only certain features of the invention have been illustrated and described herein, many modifications and changes will occur to those skilled in the art. It is, therefore, to be understood that the appended claims are intended to cover all such modifications and changes as fall within the true spirit of the invention.

1. A method of operating a hydrocarbon extraction field with the aid of a computer, the method comprising:
programming the computer with a virtual flow meter model, said model written with a notation that represents at least one of mass flow, temperature and pressure at extremities of a plurality of pressure loss elements (PLEs), said PLEs including a plurality of wells located in said hydrocarbon extraction field;
estimating, by said computer, using said model, respective mass flow rates from a plurality of said wells; and
controlling elements of the hydrocarbon extraction field based at least in part on said estimated mass flow rates.

2. The method of claim 1, further comprising:
receiving sensor data from sensors installed in association with said PLEs; and
providing the sensor data to the computer as a basis for said estimating.

3. The method of claim 2, wherein said estimating includes solving an optimization problem for minimizing a difference between said sensor data and expected values of said sensor data.

4. The method of claim 3, wherein said optimization problem is stated as a deterministic optimization problem.

5. The method of claim 3, wherein said optimization problem is written as:
$${m}^{*} = {argmin}_{\{ {m}_{j} ( i ) \} , j ∈ W} {\sum }_{i = k - H}^{k} {‖ z ( i ) - \hat{z} ( i ) ‖}^{2} ,$$
where m* is a vector of mass flow rates, W is a set of said wells, z is a vector of sensor data and \hat{z} is a vector of expected values of said sensor data.

6. The method of claim 3, wherein said optimization problem is stated as a probabilistic optimization problem.

7. The method of claim 1, wherein said hydrocarbon extraction field is an undersea field.

8. The method of claim 1, wherein said controlled elements include at least one of: (a) an effluent injection element; and (b) a valve.

9. The method of claim 8, wherein said controlled elements include a plurality of valves.

10. The method of claim 1, wherein each of said wells is represented in said model as a PLE having only one respective extremity, said only one respective extremity being a respective outlet.

11. The method of claim 1, wherein the model is in a form of a directed graph that is formed of edges and nodes that represent said PLEs.

12. The method of claim 11, wherein each of said nodes is subject to at least a constraint that, at a given time, the total of mass flow at inlets of said each node is equal to a total of mass flow at outlets of said node.

13. The method of claim 12, wherein some of said nodes are junction points, said junction points subject to at least one additional constraint that, for each junction point, at a given time, respective pressure values are equal at all extremities of said each junction point.

14. A method of operating a hydrocarbon extraction field with the aid of a computer, the method comprising:
programming the computer with a virtual flow meter model, said model at least partially in the form of equations that represent a directed graph, said directed graph formed of edges and nodes, each of said edges and nodes representative of a respective pressure loss element (PLE) that is part of an equipment installation in said hydrocarbon extraction field, a plurality of said PLEs each representing a respective well located in said hydrocarbon extraction field;
estimating, by said computer, using said model, respective mass flow rates from a plurality of said wells; and
controlling elements of said equipment installation based at least in part on said estimated mass flow rates.

15. The method of claim 14, further comprising:
receiving sensor data from sensors installed in association with said PLEs; and
providing the sensor data to the computer as a basis for said estimating.

16. The method of claim 15, wherein said estimating includes solving an optimization problem for minimizing a difference between said sensor data and expected values of said sensor data.

17. The method of claim 14, wherein said controlled elements include at least one of: (a) an effluent injection element; and (b) a valve.

18. A method of operating a hydrocarbon extraction field with the aid of a computer, the method comprising:
programming the computer with a virtual flow meter model, said model at least partially in the form of equations that represent a directed graph, said directed graph formed of edges and nodes, each of said edges and nodes representative of a respective pressure loss element (PLE) that is part of an equipment installation in said hydrocarbon extraction field, a plurality of said PLEs each being a respective well located in said hydrocarbon extraction field, some but not all of said PLEs each having at least one sensor installed in association with said each PLE, said model written with a notation that represents at least one of mass flow, temperature and pressure at extremities of said PLEs that are represented by said nodes and edges of the directed graph, said model including a plurality of constraint equations, said PLEs including at least one valve, at least one pipe and at least one junction, said sensors for providing data indicative of at least one of pressure, temperature and mass flow at each of some but not all of said extremities of said PLEs;
receiving, by said computer, said data from said sensors;
estimating, by said computer, using said model, based at least in part on said received data, respective mass flow rates from a plurality of said wells; and
controlling elements of the hydrocarbon extraction field based at least in part on said estimated mass flow rates.

19. The method of claim 18, wherein the plurality of constraint equations include a mass flow constraint equation.

20. The method of claim 19, wherein said estimating includes solving an estimation problem for minimizing a difference between said received data and expected values of said data.
